(19) United States
(12) Patent Application Publication
(10) Pub. No.: US 2024/0215559 A1
(43) Pub. Date: Jul. 4, 2024

(54) LINE-WINDING DEVICE, FISHING REEL, AND WINCH

(71) Applicant: GLOBERIDE, INC., Higashi Kurume-shi, Tokyo (JP)

(72) Inventors: Hiromu YASUDA, Higashi Kurume-shi (JP); Yutaro ABE, Higashi Kurume-shi (JP)

(73) Assignee: GLOBERIDE, INC., Higashi Kurume-shi, Tokyo (JP)

(21) Appl. No.: 18/288,212

(22) PCT Filed: Dec. 6, 2021
(86) PCT No.: PCT/JP2021/044655

§ 371 Date: Oct. 25, 2023

(30) Foreign Application Priority Data
Apr. 27, 2021 (JP) 2021-074977

(51) Int. Cl. A01K 89/015

(52) U.S. Cl. CPC A01K 89/0178; A01K 89/01931

(57) ABSTRACT

A line-winding device including a tension detection unit that can be incorporated in a reel, can be downsized, and can measure a tension with high accuracy even at the time of stopping without the need to bend a line path. A line-winding device is configured to include: a spool capable of winding a fishing line; an operating part for winding the fishing line around the spool; a support shaft portion for rotatably supporting the spool; a restoring force generation unit for generating a restoring force between the support shaft portion and the spool; a restricting part for restricting a rotational movement amount of the spool; and a detection unit for detecting the rotational movement amount of the spool.

### TECHNICAL FIELD

The present invention relates to a line-winding device, a fishing reel, and a winch capable of detecting tension with high accuracy even at the time of stopping.

### BACKGROUND ART

In a line-winding device such as a fishing reel, by detecting a tension of a line, it is possible to prevent line entanglement by detecting the presence or absence of line slack, and to perform fishing efficiency by detecting the presence or absence of fish strike. Conventionally, various methods have been proposed as a method for detecting the tension of the line.

For example, Patent Literature 1 discloses a tubular rod body constituting a fishing rod used for fishing, the rod body including: a tubular main body portion formed by firing a prepreg material in which carbon fibers are impregnated with a synthetic resin; a piezoelectric element band extending in an axial direction and disposed on a peripheral surface of the main body portion; a bottom plug detachably attached to a rod base side end of the main body portion; and a boosting means for boosting an input voltage from the piezoelectric element band disposed in the bottom plug, in which a first electrode layer, an insulating layer, a light emitting layer, a second electrode layer, and a surface layer are laminated in this order from the peripheral surface of the main body portion on the peripheral surface of the main body portion, and a voltage from the boosting means pressurizes between the first electrode layer and the second electrode layer.

Further, Patent Literature 2 discloses a fishing sensor including: a detection unit that detects vibrations applied to a fishing line due to a bite of a fish; and a means of converting the detected signal into an electrical signal, inputting it to a signal processing circuit, and converting analog changes in the processed signal into a different type of sound or light.

Furthermore, Patent Literature 3 discloses a fishing reel including: a rotating body that winds a fishing line; a bearing portion that allows displacement of the rotating body corresponding to a tension acting on the fishing line from the rotating body; a sensor that measures the tension acting on the fishing line based on the displacement of the rotating body; and a notification device that outputs a measurement result from the sensor, in which the notification device and the sensor each is housed in a single waterproof case.

### CITATION LIST

### Patent Literature

Patent Literature 1: JP 2004-008005 A
Patent Literature 2: JP S64-037238 A
Patent Literature 3: JP H05-184271 A

### SUMMARY OF INVENTION

### Technical Problem

However, in the rod body according to Patent Literature 1, deflection and vibration of the rod body are detected with the rod body as a detection target, but there is a problem that the deflection and vibration can be detected only when the rod body is at a specific position, for example, they cannot be detected when the rod body and the fishing line are straightened.

Further, in the fishing sensor according to Patent Literature 2, the fishing line is set as a detection target, the fishing line is bent by providing a guide part such as a pulley, and a force applied to the outside by the tension is detected at the bent point, however, since it is necessary to bend a line path for detecting the tension, there is a problem that it can be a resistance when it is desired to feed the fishing line at a high speed such as during casting, and it is difficult to miniaturize the entire tackle. Furthermore, in the fishing reel according to Patent Literature 3, since the rotating body can be displaced by an external force other than the tension, there is a problem that it is practically difficult to detect an accurate tension from the displacement of the rotating body.

The present invention has been made in view of the above circumstances, and an object of the present invention is to provide a line-winding device comprising a tension detection unit that can be incorporated in a reel, can be downsized, and can measure a tension with high accuracy even at the time of stopping without the need to bend the line path. Objects of the present invention other than the object will be apparent by reference to the entire specification.

### Solution to Problem

A line-winding device according to an embodiment of the present invention is configured to comprise: a spool capable of winding a fishing line; an operating part for winding the fishing line around the spool; a support shaft portion for rotatably supporting the spool; a restoring force generation unit for generating a restoring force between the support shaft portion and the spool; a restricting part for restricting a rotational movement amount of the spool; and a detection unit for detecting the rotational movement amount of the spool.

The line-winding device according to an embodiment of the present invention is configured to comprise: a fishing line diameter detection unit for detecting a diameter of the fishing line wound around the spool; and a tension calculation unit for calculating a tension from the diameter of the fishing line and the rotational movement amount of the spool.

A line-winding device according to an embodiment of the present invention is configured to comprise: a spool capable of winding a fishing line; a support shaft portion for pivotally supporting the spool rotatably; an operating part capable of rotatably operating the support shaft portion; a restoring force generation unit for applying a restoring force between the support shaft portion and the spool; a part to be detected movable in an axial direction of the support shaft portion; a detection unit for detecting an axial displacement of the part to be detected; and a conversion mechanism for converting a movement in a rotation direction of the spool and transmitting the converted movement to the part to be detected.

In the line-winding device according to an embodiment of the present invention, the restoring force generation unit is a spring member.

In the line-winding device according to an embodiment of the present invention, the conversion mechanism is a cam structure or a screw structure.

In the line-winding device according to an embodiment of the present invention, the detection unit is a non-contact position detection means, and comprises a light emitting part for projecting light to the part to be detected, and a receiver for receiving light of the light emitting part.

In the line-winding device according to an embodiment of the present invention, a permanent magnet is provided in the part to be detected, and the detection unit is a non-contact position detection means, and is a magnetic detection unit for detecting magnetism of the permanent magnet provided in the part to be detected.

In the line-winding device according to an embodiment of the present invention, a sound wave reflecting part is provided in the part to be detected, and the detection unit is a non-contact position detection means, and is a sound wave detection unit for detecting a sound wave from the sound wave reflecting part provided in the part to be detected.

The line-winding device according to an embodiment of the present invention is a fishing reel.

The line-winding device according to an embodiment of the present invention is a winch.

### Advantageous Effects of Invention

According to the embodiments described above, it is possible to provide the line-winding device comprising the tension detection unit that can be incorporated in the reel, can be downsized, and can measure a tension with high accuracy even at the time of stopping without the need to bend the line path.

### BRIEF DESCRIPTION OF DRAWINGS

FIG. 1 is a view for explaining an exploded perspective view of a line-winding device according to an embodiment of the present invention.

FIG. 2 is a view for explaining an exploded perspective view of the line-winding device according to an embodiment of the present invention.

FIG. 3 is a view for explaining a cross-sectional view of the line-winding device according to an embodiment of the present invention.

### DESCRIPTION OF EMBODIMENTS

Hereinafter, an embodiment of a line-winding device according to the present invention will be specifically described with reference to the accompanying drawings. Components common in a plurality of drawings are denoted by the same reference signs throughout the plurality of drawings. It should be noted that the drawings are not necessarily drawn to scale for convenience of description.

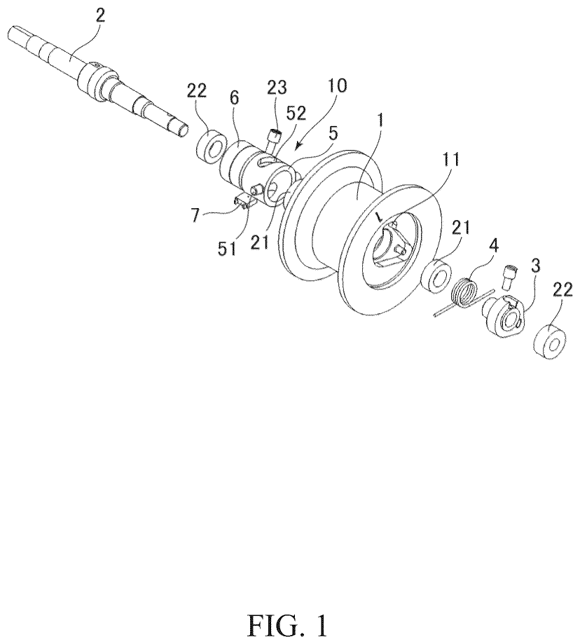

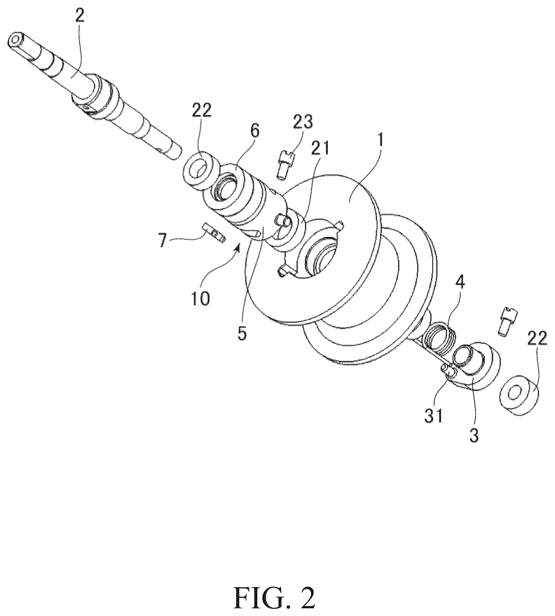

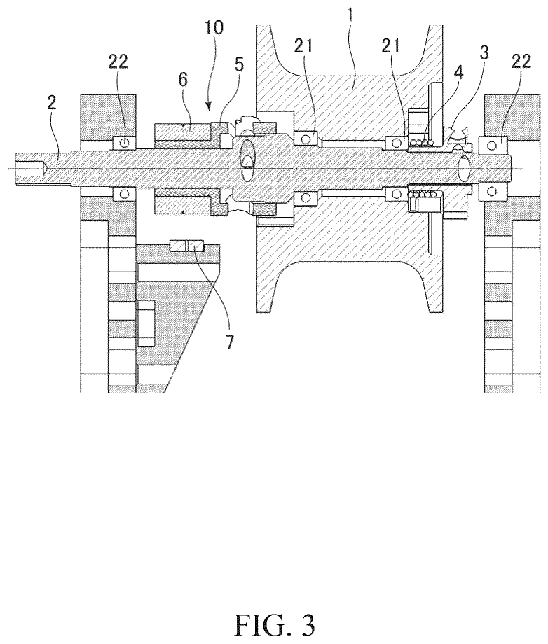

First, a configuration of a line-winding device 100 according to an embodiment of the present invention will be described with reference to FIGS. 1 to 3. Note that in order to simplify the description, only a portion of a tension detection mechanism will be described in the following description, and a description of portions similar to those of the conventional line-winding device will be omitted. First, FIGS. 1 and 2 illustrate exploded perspective views of the line-winding device 100, and FIG. 3 illustrates a cross-sectional view taken along a cross-section passing through a central axis of the line-winding device 100.

As illustrated in these drawings, the line-winding device 100 according to an embodiment of the present invention comprises a spool 1, a support shaft portion (also referred to as a support shaft, but hereinafter referred to as a support shaft portion) 2, a rotation restricting part 3, a restoration unit (restoration means) 4, a straight advance member 5, a part to be detected (means to be detected) 6, and a detection unit (detection means) 7. The spool 1 is formed in a cylindrical shape, and is configured to be able to wind a fishing line by an outer peripheral portion of the spool. Note that in the following description, a central axis direction of the spool 1 is defined as an axial direction, and a rotation direction of the spool is defined as a rotation direction.

The support shaft portion 2 is formed in a substantially columnar shape, and pivotally supports the spool 1 rotatably by a bearing 21. Further, the support shaft portion 2 is pivotally supported rotatably by a bearing 22 with respect to a main body portion of the line-winding device 100 (not illustrated), and can be rotated by operating a known operating means (also not illustrated). The line can be wound around the spool 1 by this operation. The operating means can rotate the support shaft portion 2, and can be realized by a combination of a device such as a handle or a lever that receives an operation of a user and a power transmission means such as a gear, a belt, or a shaft. A power source such as a motor or an engine may be used as necessary. Further, a drag device (torque limiter) that sets a limit on a power to be transmitted and a clutch device that switches availability of power transmission may be provided. Furthermore, a reverse rotation prevention mechanism such as a one-way clutch or a ratchet may be provided in a part of the operating means, to prevent the spool 1 from inadvertently rotating backward.

Further, the rotation restricting part 3 is fixed to the support shaft portion 2, and restricts an angular movement amount of the spool 1 with respect to the support shaft portion 2 within a predetermined range. In an embodiment of the present invention, a dowel 31 provided in the rotation restricting part hits both ends of a gap 11 provided in the spool 1. Thus, the spool 1 is configured to be rotatable at an angle in a range of 0° to 60° with respect to the support shaft 2. Hereinafter, this angle is defined as θ.

The restoration unit (restoration means) 4 can generate a predetermined restoring force in the spool 1. In an embodiment of the present invention, the restoration unit can be formed by a spring member (for example, a torsion spring), one end of the spring member contacts the rotation restricting part 31 and the other end of the spring member contacts the spool 1. Thus, when a torque T acting on the spool 1 is equal to or less than a predetermined value, the spool 1 is biased by the spring so that θ=0°. Then, the angle θ increases as the torque increases. In an embodiment of the present invention, a central axis of the torsion spring is substantially coaxial with a central axis of the spool 1, so that an increase amount of the torque T is proportional to a displacement amount of the angle θ, and when a value of the torque T is a predetermined value or more, the rotation restricting part and one end of the gap of the spool comes into contact with each other, so that the angle θ=60°. As the restoration unit (restoration means), other methods of generating the restoring force such as using a magnetic force generated by the permanent magnet may be used in addition to an elastic spring as described above.

The straight advance member 5 is formed in a substantially cylindrical shape, and is supported to be able to advance straight in the axial direction with respect to the support shaft 2. When the straight advance member receives a transmission force in the rotation direction from the spool 1 by a rotation transmission portion 51, it moves in the rotation direction by the angle θ together with the spool 1 with respect to the support shaft 2. A cam groove 52 formed in a spiral shape is provided in a side surface portion of the straight advance member 5, to form a cam mechanism as a conversion mechanism 10 together with a follower pin 23 fixed to the support shaft 2. With this cam mechanism, the straight advance member 5 also moves in the axial direction according to a rotational movement. That is, it is configured such that the displacement amount of the angle θ of the spool 1 in the rotation direction is converted into a movement amount X in the axial direction of the straight advance member 5, and in an embodiment of the present invention, it is configured such that the straight advance member 5 moves 2 mm in the axial direction when the angle θ moves by 60°.

Note that the conversion mechanism in an embodiment of the present invention is not limited to the above configuration, and the same effect can be obtained by other configurations. For example, a screw mechanism, that is, a female screw portion and a male screw portion are respectively provided in the spool 1 and the straight advance mechanism 5, and screwed together, and the straight advance member 5 is supported to be movable straight with respect to the support shaft 2, so that the rotational movement of the spool 1 can be converted into a straight advance movement in the axial direction of the straight advance member 5 by the screw mechanism. Further, the conversion mechanism in an embodiment of the present invention may be a mechanism other than the cam mechanism and the screw mechanism.

The part to be detected (means to be detected) 6 is fixed to the straight advance member 5, and the movement in the axial direction can be detected by the detection means 7 disposed on a reel main body. In an embodiment of the present invention, the part to be detected (means to be detected) 6 is the permanent magnet, and the detection unit (detection means) 7 is a known magnetic sensor such as a Hall element. Magnetization characteristics and the like can be adjusted such that a voltage value of the detection unit (detection means) increases in proportion to the movement amount of the part to be detected (means to be detected) 6 in the axial direction.

In addition, the part to be detected (means to be detected) 6 has a symmetrical characteristic in the rotation direction. In an embodiment of the present invention, the part to be detected is formed in a cylindrical shape and is magnetized without unevenness in the rotation direction. Thus, even when the means to be detected rotates, an output from the detection means can be configured not to change unless there is no movement amount in the axial direction.

Note that a combination of the part to be detected 6 and the detection unit 7 is not limited to a magnetic type as described above. A conventionally known displacement detection method can be used, such as an optical detection method in which, for example, a photosensor such as a PSD is used as the detection unit and a light shielding plate or a reflector is used as the part to be detected, or an ultrasonic detection method in which an ultrasonic reception unit and an ultrasonic transmission unit are used as the detection unit and a sound wave reflecting part is used as the part to be detected.

The combination of the part to be detected 6 and the detection unit 7 is better if a displacement of the part to be detected in the axial direction can be detected in a non-contact manner. This makes it possible to avoid occurrence of sliding resistance when the support shaft portion 2 is rotated.

The line-winding device 100 according to an embodiment of the present invention is configured to comprise: the spool 1 capable of winding a fishing line; an operating part for winding the fishing line around the spool 1; the support shaft portion 2 for rotatably supporting the spool 1; a restoring force generation unit (restoration unit) 4 for generating the restoring force between the support shaft portion 2 and the spool 1; the restricting part (rotation restricting part) 3 for restricting a rotational movement amount of the spool 1; and a detection unit 7 for detecting the rotational movement amount of the spool 1.

According to the line-winding device 100 of an embodiment of the present invention, it is possible to provide the line-winding device comprising the tension detection unit that can be incorporated in the reel, can be downsized, and can measure a tension with high accuracy even at the time of stopping without the need to bend the line path.

The line-winding device 100 according to an embodiment of the present invention is configured to comprise: a fishing line diameter detection unit for detecting a diameter of the fishing line wound around the spool 1; and a tension calculation unit for calculating a tension from the diameter of the fishing line and the rotational movement amount of the spool.

A line-winding device 100 according to an embodiment of the present invention is configured to comprise: the spool 1 capable of winding the fishing line; the support shaft portion 2 for pivotally supporting the spool 1 rotatably; an operating part capable of rotatably operating the support shaft portion 2; the restoring force generation unit (restoration unit) 4 for applying the restoring force between the support shaft portion 2 and the spool 1; the part to be detected 6 movable in the axial direction of the support shaft portion 2; the detection unit 7 for detecting the axial displacement of the part to be detected 6; and the conversion mechanism 10 for converting the movement in the rotation direction of the spool 1 and transmit the converted movement to the part to be detected 6.

According to the line-winding device 100 of an embodiment of the present invention, it is possible to provide the line-winding device comprising the tension detection unit that can be incorporated in the reel, can be downsized, and can measure a tension with high accuracy even at the time of stopping without the need to bend the line path.

In the line-winding device 100 according to an embodiment of the present invention, the restoring force generation unit (restoration unit) 4 is the spring member.

In the line-winding device 100 according to an embodiment of the present invention, the conversion mechanism 10 is the cam mechanism (cam structure) or the screw mechanism (screw structure).

In the line-winding device 100 according to an embodiment of the present invention, the detection unit 7 is a non-contact position detection means, and comprises a light emitting part for projecting light to the part to be detected 6, and a receiver for receiving light of the light emitting part.

In the line-winding device 100 according to an embodiment of the present invention, a permanent magnet is provided in the part to be detected 6, and the detection unit 7 is the non-contact position detection means, and is a magnetic detection unit for detecting magnetism of the permanent magnet provided in the part to be detected 6.

In the line-winding device 100 according to an embodiment of the present invention, the sound wave reflecting part is provided in the part to be detected 6, and the detection unit 7 is the non-contact position detection means, and is a sound wave detection unit for detecting a sound wave from the sound wave reflecting part provided in the part to be detected 6.

The line-winding device according to an embodiment of the present invention is a fishing reel. Further, the line-winding device according to an embodiment of the present invention is a winch. Here, the line-winding device according to an embodiment of the present invention is not limited to the fishing reel and the winch.

Next, a method for detecting a tension acting on the line by the line-winding device 100 will be described. As described above, in the line-winding device 100 according to an embodiment of the present invention, when the torque acts on the spool 1, the spool 1 moves in the rotation direction with respect to the support shaft portion 2 according to a magnitude of the torque. In an embodiment of the present invention, the restoration unit (restoration means) 4 is configured to have characteristics such that θ=0° when the magnitude of the torque is 10 gcm or less, θ=60° when the magnitude of the torque is 100 gcm or more, and the movement amount θ changes in proportion to a change amount of the torque between 0° and 60°. Then, the cam mechanism moves the straight advance member 5 in the axial direction according to the movement amount θ of the spool 1 in the rotation direction. In an embodiment of the present invention, the cam groove 51 is formed such that the movement amount θ in the rotation direction is proportional to the movement amount X in the axial direction. Thus, since the means to be detected 6 provided in the straight advance member 5 moves by X in the axial direction, the movement can be detected by the detection unit (detection means) 7. Therefore, the torque acting on the spool 1 can be calculated by observing the output of the detection unit 7.

Note that the torque acting on the spool 1 is obtained by multiplying a tension T acting on the fishing line by a winding radius R of the line. The winding radius R of the fishing line can change according to a rotation amount of the spool 1, but the tension T acting on the line can also be calculated by obtaining the winding radius R of the fishing line by another means.

In order to obtain the winding radius R of the fishing line, a conventionally known method can be used. For example, there are a method of measuring a distance from a line-winding device main body to the fishing line wound around an outer peripheral portion of the spool with an ultrasonic distance meter or the like, a method of calculating a line winding radius R by inputting a line winding radius Rmax and a thickness ΔD of the line in an initial state in advance and constantly measuring the rotation amount of the spool 1 from the initial state, a method of using a shallow groove-shaped spool (long shape in the axial direction with a little difference between the minimum and maximum diameters) in which a change in the line winding radius can be ignored within a range of use, and the like.

At this time, even if the spool 1 or the means to be detected 6 is rotated by the operating means, an axial position of the means to be detected 6 does not change as long as the torque acting on the spool 1 does not change. Since the means to be detected 6 is symmetric in the rotation direction, there is no change in a signal obtained from the detection means 7. Therefore, it is possible to stably detect the torque acting on the spool 1 regardless of a position of the support shaft 2 in the rotation direction. Note that in order to prevent the output of the detection unit 7 from changing due to a backlash of the support shaft 2 in the axial direction, it is recommended to take a method such as reducing allowance in the axial direction of the support shaft 2, pushing the spool to one side in the axial direction using a spring or the like, or setting a movable amount x in the axial direction to be sufficiently larger than an amount of backlash or an assembly error.

In addition, as a method of using the detected tension, there is an information transmission to the user. The torque acting on the spool 1 and information on the tension acting on the fishing line obtained by the above-described method can be transmitted to the user by being output to a display device such as an LCD or a sound information generation device such as a speaker. Thus, the presence or absence of fish strike and the presence or absence of line slack can be determined, and a state of the line-winding device can be grasped.

Further, as another method of using the detected tension, the tension information may be transmitted to the microcomputer, and the history may be stored, for example, in an external device such as a memory or a smartphone. Thus, it is possible to grasp a change in a short period and a change in a long period which are difficult to visually recognize. Furthermore, the tension information may be used for a control object when performing feedback control of an external device such as a motor of the operating means or a drag device. Thus, various controls such as winding at a constant tension can be realized.

Next, according to the line-winding device according to an embodiment of the present invention, the tension acting on the line can be measured without bending the line path as compared with a method of bending the line. Thus, a mechanism for bending the line path is not necessary, and an increase in size of the entire device can be avoided. Further, since there is no unnecessary bent point in the line path, it is possible to avoid being an obstacle when the line comes out at high speed at the time of casting or the like.

In the line-winding device according to an embodiment of the present invention, as compared with a method of detecting a strain and displacement of a reel constituent member, a straight-running member is configured to move in the axial direction according to a torque applied to the spool, and the torque can be obtained by detecting a movement amount in the axial direction. It is often difficult to apply the tension to the spool by a method other than increasing a line tension due to a structure of the line-winding device, and the spool is not torqued even when an external force is applied to the line-winding device main body. Thus, it is possible to realize torque measurement and tension measurement that are stable against external disturbances as compared with a method of detecting strain of a main body frame or the like that pivotally supports the spool.

According to the line-winding device according to an embodiment of the present invention, the tension can be detected even when the operating means is stopped or rotated, as compared with a method of detecting the tension by the motor.

Dimensions, materials, and arrangements of the components described in this specification are not limited to those explicitly described in the embodiments, and the components may be modified to have any dimensions, materials, and arrangements that may fall within the scope of the present invention. Further, components not explicitly described herein can be added to the described embodiments, or some of the components described in each embodiment can be omitted.

### REFERENCE SIGNS LIST

1 spool
2 support shaft portion
3 restricting part (rotation restricting part)
4 restoration unit (restoration means)
5 straight advance member
6 part to be detected
7 detection unit
10 conversion mechanism
100 line-winding device

1. A line-winding device comprising: a spool capable of winding a fishing line; an operating part for winding the fishing line around the spool; a support shaft portion for rotatably supporting the spool; a restoring force generation unit for generating a restoring force between the support shaft portion and the spool; a restricting part for restricting a rotational movement amount of the spool; and a detection unit for detecting the rotational movement amount of the spool.

2. The line-winding device according to claim 1, comprising: a fishing line diameter detection unit for detecting a diameter of the fishing line wound around the spool; and a tension calculation unit for calculating a tension from the diameter of the fishing line and the rotational movement amount of the spool.

3. A line-winding device comprising: a spool capable of winding a fishing line; a support shaft portion for pivotally supporting the spool rotatably; an operating part capable of rotatably operating the support shaft portion; a restoring force generation unit for applying a restoring force between the support shaft portion and the spool; a part to be detected movable in an axial direction of the support shaft portion; a detection unit for detecting an axial displacement of the part to be detected; and a conversion mechanism for converting a movement in a rotation direction of the spool and transmitting the converted movement to the part to be detected.

4. The line-winding device according to claim 3, wherein the restoring force generation unit is a spring member.

5. The line-winding device according to claim 3, wherein the conversion mechanism is a cam structure or a screw structure.

6. The line-winding device according to claim 3, wherein the detection unit is a non-contact position detection means, and comprises a light emitting part for projecting light to the part to be detected, and a receiver for receiving light of the light emitting part.

7. The line-winding device according to claim 3, wherein
a permanent magnet is provided in the part to be detected, and
the detection unit is a non-contact position detection means, and is a magnetic detection unit for detecting magnetism of the permanent magnet provided in the part to be detected.

8. The line-winding device according to claim 3, wherein
a sound wave reflecting part is provided in the part to be detected, and
the detection unit is a non-contact position detection means, and is a sound wave detection unit for detecting a sound wave from the sound wave reflecting part provided in the part to be detected.

9. A fishing reel, wherein the line-winding device according to claim 1 is the fishing reel.

10. A winch, wherein the line-winding device according to claim 1 is the winch.
